(19) United States
(12) Patent Application Publication
(10) Pub. No.: US 2026/0007573 A1
(43) Pub. Date: Jan. 8, 2026

(54) Assembly for Sterile Connecting Vials

(71) Applicant: Miltenyi Biotec B.V. & Co KG, Bergisch Gladbach (DE)

(72) Inventors: Stefan Miltenyi, Bergisch Gladbach (DE); Manuel HEILIG, Bergisch Gladbach (DE); Carlo PANNEN, Bergisch Gladbach (DE)

(73) Assignee: Miltenyi Biotec B.V. & Co KG, Bergisch Gladbach (DE)

(21) Appl. No.: 19/248,770

(22) Filed: Jun. 25, 2025

(30) Foreign Application Priority Data
Jul. 2, 2024 (EU) EP24185869.5

(51) Int. Cl. A61J 1/20

(52) U.S. Cl. CPC A61J 1/2055; A61J 1/202; A61J 1/2051; A61J 1/2065

(57) ABSTRACT

An assembly (10) contains a aseptic flow of a liquid out of a container (20). The container (20) holding the liquid and an adapter (30) is configured to mechanically engage with the container (20)

### CROSS REFERENCE TO RELATED APPLICATIONS

This US non Provisional patent application claims priority to EP 24185869.5, filed Jul. 2, 2024. This prior application is incorporated by reference in its entirety.

### STATEMENT REGARDING FEDERALLY SPONSORED RESEARCH

Not applicable.

### STATEMENT REGARDING MICROFICHE APPENDIX

Not applicable.

### BACKGROUND

The present invention is directed to an assembly (10) for aseptic flow (removal) of a liquid from a container (20) via an adapter (30) for example to a tubing set.

In some technical fields like medicine or biology, it is often required to transfer fluids from one container or device to another under sterile conditions, i.e. at best in absence of any contamination by pollutants, dust, bacteria, viruses, or spores or the like. Unavoidable, connections between the containers have to be provided which may jeopardize sterility.

Devices for sterile connection of tubes, containers or bags in an unsterile environment are known in many variants as “sterile connectors” or simply “connectors”. Some of these connectors ensure sterility i.e. aseptic flow by providing a connecting device having two parts which are provided with openings for the aseptic flow covered by a releasable foil. After mechanically combining the parts, the foils are removed from both parts at once and a sterile connection through the openings is provided. Such connectors are for example disclosed in EP3459633B1, WO2024008899, U.S. Pat. Nos. 10,350,400 or 10,099,047.

The known connecting system are usually design to connect tubes, for example tubes extending from freezing bags or the like.

However, long-term sterile storage of samples, media, chemicals etc for biological or medical use is often provided by containers (so called “vials”) having a septum which needs to be pierced with a sharp, hollow object in order to withdraw the content of the container. Since during the piercing process sterility needs to be maintained, piercing and connecting the container should be performed under sterile conditions too. Maintaining sterile conditions while performing manual work requires additional effort like working under a sterile bench or in a clean room.

Containers (vials) in biological industry or medical purposes have a standard size and shape, defined in norm DIN ISO 8362. Accordingly, no other size and shape will be acceptable in the industry.

Obviously, there was a need for a device to allow removal of a liquid from a vial under sterile conditions without the need of expensive equipment.

### SUMMARY

Object of the invention is an assembly (10) for aseptic flow of a liquid out of a container (20) comprising a container (20) holding the liquid and an adapter (30) configured to mechanically engage with the container (20) characterized in that
a) the container (20) comprises at least one first opening (21a) covered by a first foil (28) and a first coupling means (23)
b) the adapter (30) comprises at least one second opening (31a) covered by a second foil (38) and a second coupling means (32) capable of mechanically engaging with the first coupling means (23) wherein the second foil (38) is attached to a handle (33);
c) the container (20) and the adapter (30) are configured such that they mechanically engage with each other by inserting the container (20) into the adapter (30) via the first and second coupling means (23, 32) such that the first (21a) and second (31a) opening are positioned on top of each other and the handle (33) mechanically engages with the foil holder (22) to provide the assembly (10) with a closed fluidic pathway between the container (20) and the adapter (30) and
d) wherein the handle (33) and the adapter (30) are configured such that by removing the handle (33) from the adapter (30), the first (28) and second foils (38) are removed from the first (21a,b) and second opening (31a,b) thereby providing an open fluidic pathway between the container (20) and an adapter (30).

As shown in the drawings, container (20) and adapter (30) are assembled by inserting the container (20) into adapter (30) via a translational movement relative to each other and not a rotational movement for example as known from bayonet closings in the prior art. Due to the insertion, the container (20) is mechanically engaged to adapter (30) (i.e. fixed) and the openings and the first and second openings (21a, 31a) are located on top of each other. The fluidic pathway from container (20) to the adapter (30) through first and second openings (21a, 31a) is aseptically closed by the first and second foils (28, 38). By inserting the container (20) into adapter (30), both foils are mechanically engaged to the handle (33) and can be removed by removing the handle (33) from adapter (30). By doing so, the first and second openings (21a, 31a) are opened and an (aseptic) fluidic pathway from container (20) to the adapter (30) through first and second openings is established.

The assembly of the invention is particular useful to withdraw fluids like reagents provided as aqueous solution or suspension under sterile conditions from a container. The container is preferrable shaped like a vial as commonly used in medical or biological applications. It is further possible to use the assembly to withdraw solid substances (reagents) like lyophilized reagents or pharmaceuticals from a container under sterile conditions by first introducing a fluid (usually water or an aqueous solution like medical buffer) into the container, solve or suspend the solid substance and then remove the obtained fluid under sterile conditions from the container.

In practice, a container is inserted into the adapter and by removing the handle mechanically connected with a foil holder, both foils are removed from the respective openings and a fluid communication between the container and the adapter (and downstream to further processing units) is provided.

In turn, the adapter (30) may be configured to be inserted into a holder for example as part of a laboratory or clinical device. The assembly of the invention ensures a sterile connection of a vial containing reagents with the device. Such laboratory or clinical device may be provided with one or more holder for one or more adapters (30) (i.e. assemblies of the invention).

Preferable, the adapter (30) is provided with appropriate connectors for tubing like a Luer lock having a fluidic connection to openings 31a,b.

### BRIEF DESCRIPTION OF THE DRAWINGS

FIG. 1: side view of assembly (10)

FIG. 2: cut-open side view of assembly (10)

FIG. 3,4: adapter (30) with handle (33)

FIG. 5: interlocking mechanism of handle (33) and adapter (30)

FIG. 6,7: bottom view of container (20)

FIG. 8: interlocking mechanism of container (20) and adapter (30)

FIG. 9: cross section of assembly (10) with first foil (28) and second foil (38)

### DETAILED DESCRIPTION

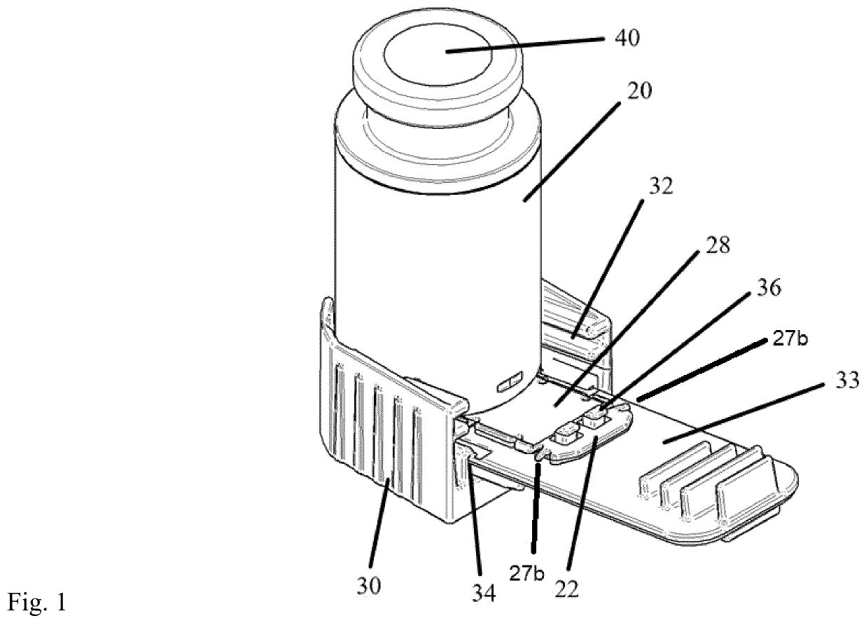

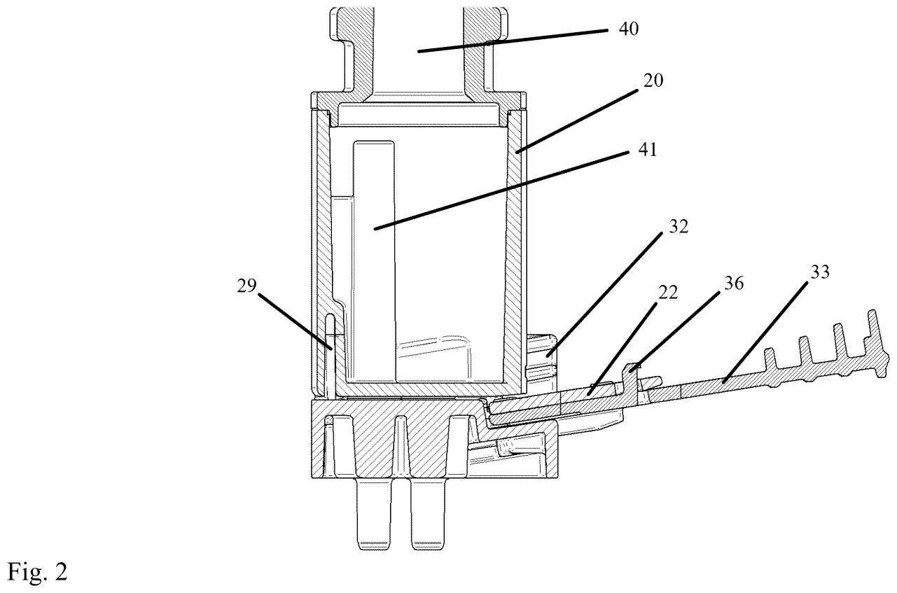

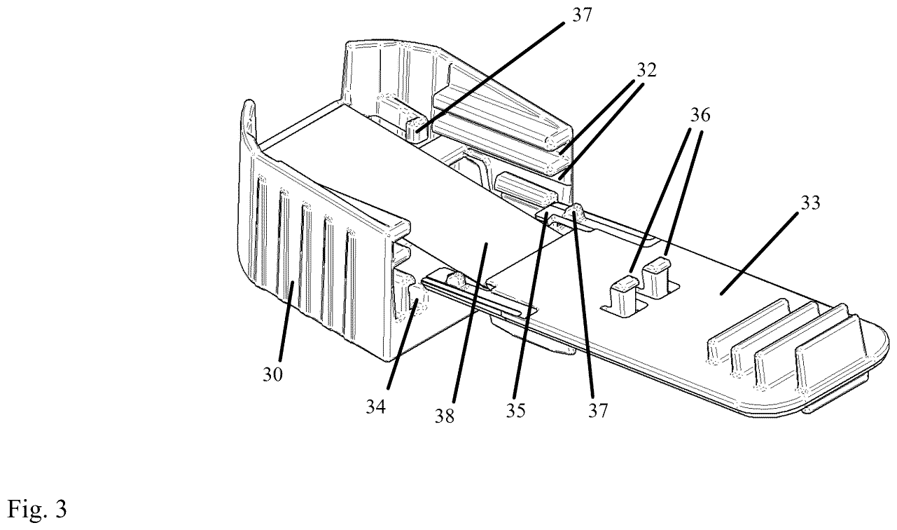

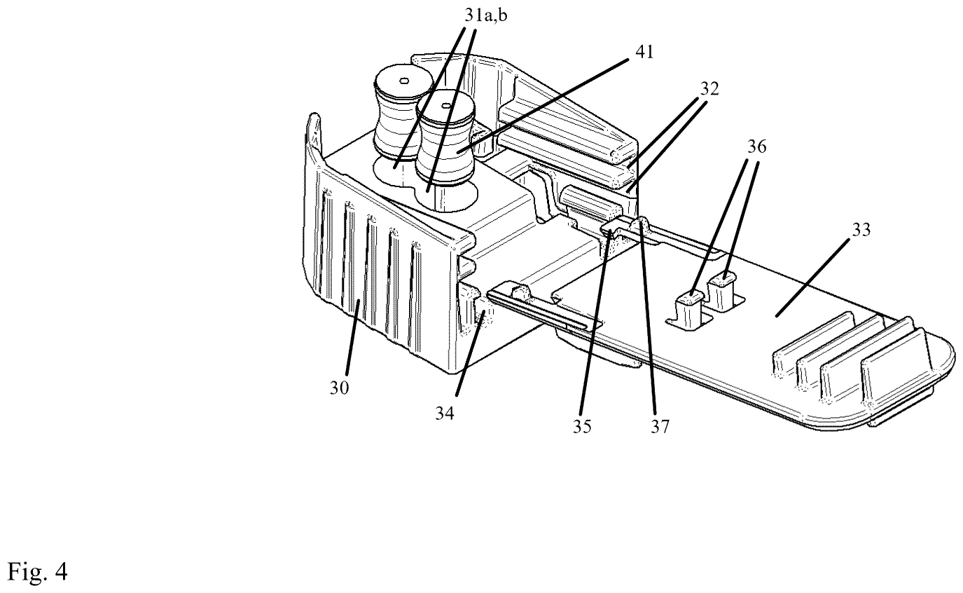

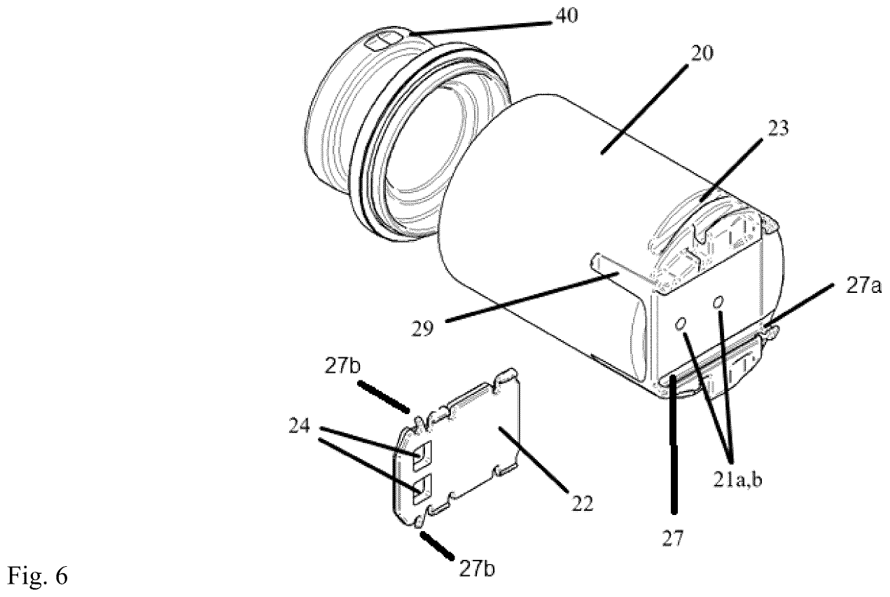

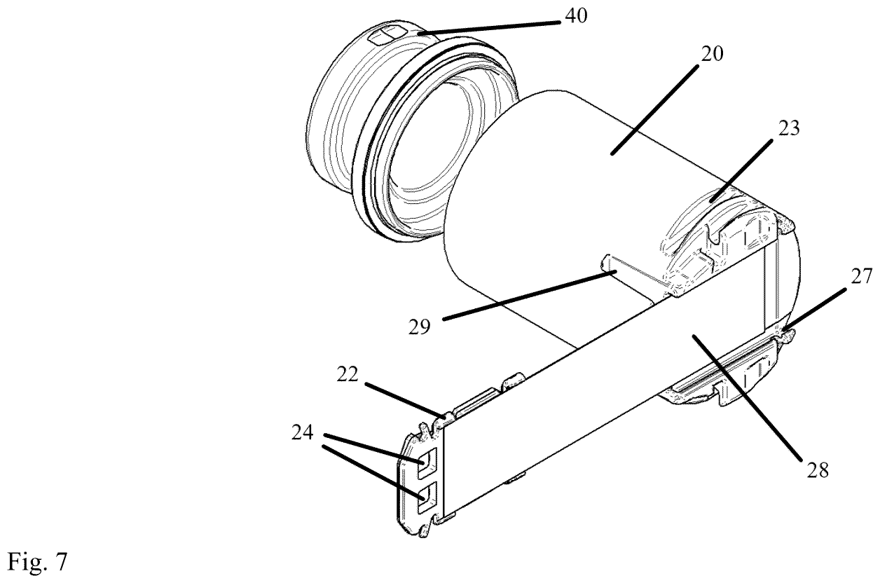

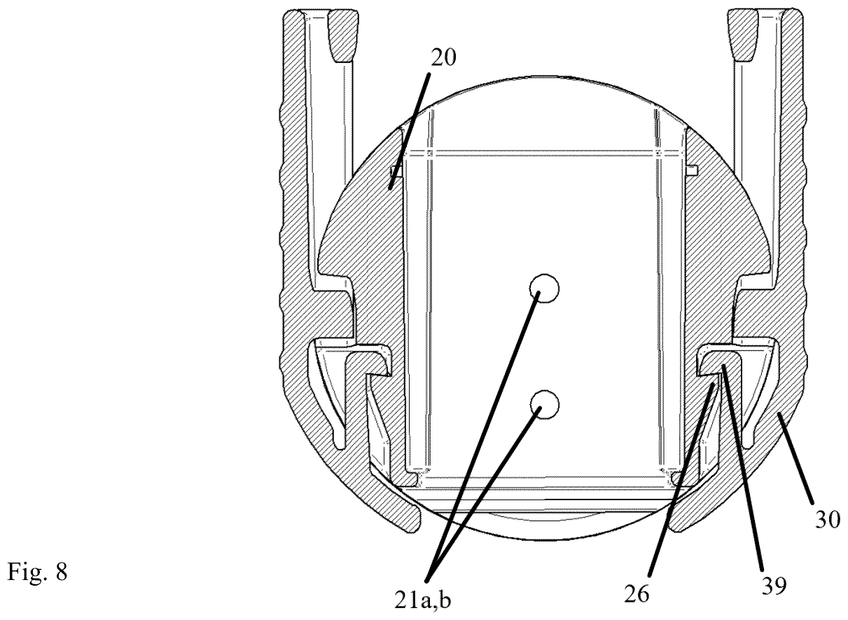

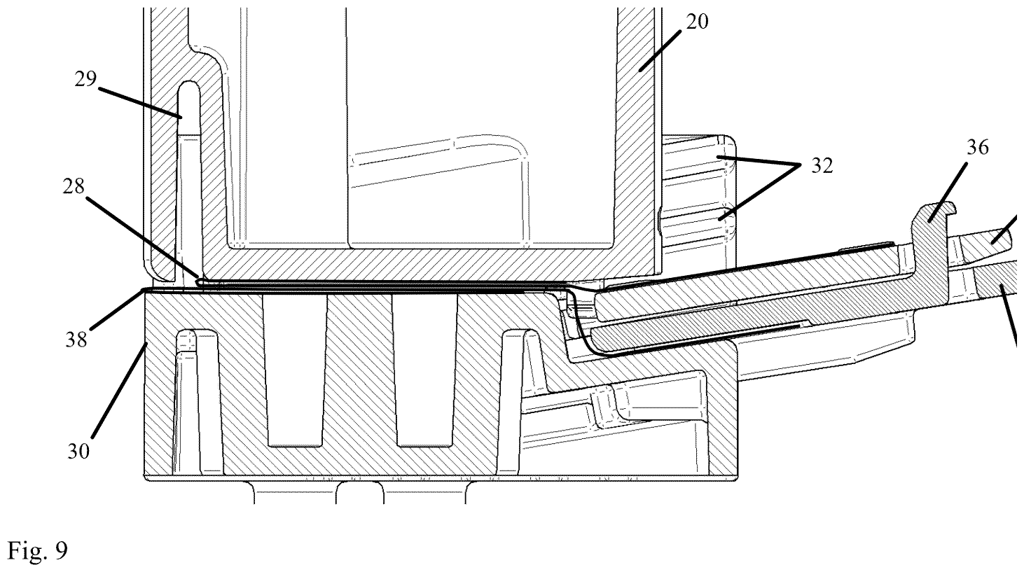

The assembly can be provided before use as separate components: container (20) and adapter (30), both provided with the first and second foils to maintain sterility of the respective openings (21) and (31). Before use, the components are completed into the assembly by mechanically interlocking with each other i.e. inserting the container (20) into the adapter (30) by the first (23) and second (32) coupling means. FIG. 1 shows a side view, FIG. 2 shows a cut open view, FIGS. 3 and 4 show greater detail in a cut-open views, FIGS. 6 and 7 show bottom views. FIG. 8 shows greater detail of the interlocking mechanism and FIG. 9 shows a cross section of the assembly with the first and second foils, as described below.

The term “capable of mechanically engaging” is synonym with the term “designed or configured for mechanically engaging” or “provided with means for mechanically engaging”.

In the following, the parts of the assembly are further explained by referring to the drawings.

The openings, especially the second openings (31) may be provided with flexible gaskets (41).

The container may have the shape of a standard vial known in laboratory or medical use and may be provided with a further opening for machine-line filling like a septum as commonly used for such vials.

In a first embodiment, the first foil (28) is attached to a foil holder (22), wherein the foil holder (22) is provided with at least one opening (24) and the handle (33) is provided with at least one protrusion (36) configured to mechanically engage with the least one opening (24) of the foil holder (22), as depicted in FIGS. 7 and 8 for example.

The first and second foils (28, 38) can be attached to the adapter, handle or foil holder (22) for example by gluing or hot melt, as shown in FIG. 9 for example.

Preferably the first coupling means (23) and second coupling means (32) are provided as complementary guiding slots or complementary tongue and groove. To ensure a precise insertion process and a mechanical stable connection, the complementary guiding slots or complementary tongue and groove can be provided more than once, like two or more pairs. Embodiments with multiple pairs are shown in the figures.

To ensure safe assembly, the adapter (30) may be provided with at least one snap-on connector (39) and the container (20) may be provided with at least one corresponding cavity (26), wherein the snap-on connector (39) and cavity (26) are configured to mechanically engage with each other.

Preferable, the adapter (30) is provided with a third coupling means (34) configured to mechanically engage with handle (33).

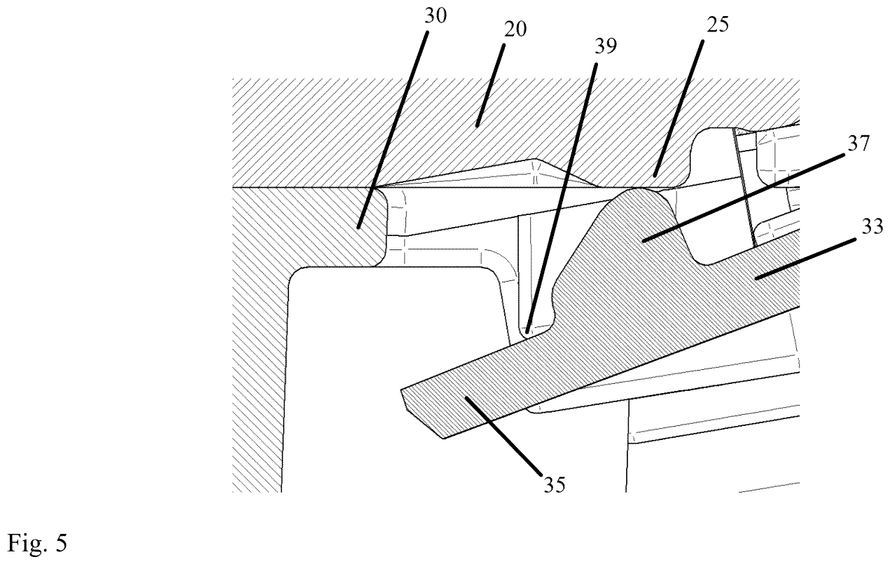

Optional, the mechanical engagement of handle (33) and adapter (30) via the third coupling means (34) is configured to be released by inserting the container (20) into the adapter (30). To this end, the container (20) may be provided with protrusion (25) and handle (33) is provided with protrusion (37) mechanically interacting with each other by inserting the container (20) into the adapter (30) thereby releasing the mechanical interlock of handle (33) and adapter (30), as shown in FIG. 5 for example.

A similar mechanical coupling can be used to insert the handle in the adapter: the third coupling means (34) can be provided as guiding slot complementary to the shape of the handle (33).

In the embodiment using foil holder (22), the container (20) is preferable provided with a fourth coupling means (27) configured to mechanically engage with the foil holder (22). The fourth coupling means (27) of the container (20) may be provided with fixation openings (27a) for the foil holder (22) and the foil holder (22) may be likewise provided with fixation hooks (27b) configured to mechanically engage with the fixation openings of the fourth coupling means (27).

By inserting the container (20) into the adapter (30), the foil holder (22) mechanically connects with the handle (33) and the first foil (28) and the second foil (38) are aligned to each other.

To this end, it is preferred that the handle (33) is capable of mechanically engaging with the foil holder (22) by providing the handle with at least one protrusion (36) and the foil holder (22) with a complementary opening (24).

Container, adapter and handle may be manufactured from any material like polymers (PC, PP, PE, PS or COP), for example by injection moulding or 3D printing. For the container, glass may be utilized too.

In another embodiment the container (20) and the adapter (30) are provided with two first openings (21a,b) and two second openings (31a,b), wherein one pair of first and second openings are provided for aseptic removal of a liquid from the container and the other pair of first and second openings are provided for aseptic flow of medium into the container.

This embodiment is useful if a constant flow of liquid is needed without pressure fluctuations and/or to provide pressure compensation to the container (20) without the danger of contamination and/or for the solving/suspending solid compounds in the container.

To increase maintenance of aseptic conditions, the first and second foils (28, 38) may be provided as double layers in form of loops, wherein one end of the first foil (28) is attached to the container (20) and the other end to the foil holder (22), and wherein one end of the second foil (38) is attached to the handle (33) and the other end is attached to the adapter (30).

Preferable, the container (20) is provided with a cavity (29) for storing at least a part of the double layered first foil (28).

Preferable, the third coupling means (34) is provided as guiding slot complementary to the shape of the handle (33).

The mechanical connection between the handle (33) and adapter (30) can be ensured by providing handle (33) with a snap-on connector (35) capable of mechanically interlocking with protrusion (39) provided at adapter (30) when inserting handle (33) into adapter (30).

In a similar way, the adapter (30) may be provided with a snap-on connector (39) capable of mechanically interlocking with cavity (26) provided at container (20) when inserting the container (20) into adapter (30).

Preferable, in this variant, the mechanical interlock of handle (33) and adapter (30) is released by inserting the container (20) into the adapter (30).

A release mechanism can be obtained by providing container (20) with protrusion (25) and handle (33) with protrusion (37) mechanically interacting with each other by inserting the container (20) into the adapter (30) thereby releasing the mechanical interlock of handle (33) and adapter (30).

The container as part of the assembly can be provided with internal tube (41) extending from one opening (21a,b) at least to 25% of the internal height of the container (20). This embodiment is useful to avoid bubble or foam formation in the container (20) by incoming gases and/or for the solving/suspending solid compounds in the container.

While various details have been described in conjunction with the exemplary implementations outlined above, various alternatives, modifications, variations, improvements, and/or substantial equivalents, whether known or that are or may be presently unforeseen, may become apparent upon reviewing the foregoing disclosure. Accordingly, the exemplary implementations set forth above, are intended to be illustrative, not limiting.

What is claimed is:

1. An assembly (10) for aseptic flow of a liquid out of a container (20) comprising a container (20) holding the liquid and an adapter (30) configured to mechanically engage with the container (20) wherein
a) the container (20) comprises at least one first opening (21a) covered by a first foil (28) and a first coupling means (23)
b) the adapter (30) comprises at least one second opening (31a) covered by a second foil (38) and a second coupling means (32) capable of mechanically engaging with the first coupling means (23) wherein the second foil (38) is attached to a handle (33);
c) the container (20) and the adapter (30) are configured such that they mechanically engage with each other by inserting the container (20) into the adapter (30) via the first and second coupling means (23, 32) such that the first (21a) and second (31a) opening are positioned on top of each other and the handle (33) mechanically engages with the foil holder (22) to provide the assembly (10) with a closed fluidic pathway between the container (20) and the adapter (30) and
d) wherein the handle (33) and the adapter (30) are configured such that by removing the handle (33) from the adapter (30), the first (28) and second foils (38) are removed from the first (21a,b) and second opening (31a,b) thereby providing an open fluidic pathway between the container (20) and an adapter (30).

2. Assembly according to claim 1 wherein the first foil (28) is attached to a foil holder (22), wherein the foil holder (22) is provided with at least one opening (24) and the handle (33) is provided with at least one protrusion (36) configured to mechanically engage with the least one opening (24) of the foil holder (22).

3. The assembly according to claim 1, wherein the adapter (30) is provided with at least one snap-on connector (39) and the container (20) is provided with at least one corresponding cavity (26), wherein the snap-on connector (39) and cavity (26) are configured to mechanically engage with each other.

4. The assembly according to claim 1, wherein the adapter (30) is provided with a third coupling means (34) configured to mechanically engage with handle (33).

5. The assembly according to claim 1, wherein the mechanical engagement of handle (33) and adapter (30) via the third coupling means (34) is configured to be released by inserting the container (20) into the adapter (30).

6. The assembly according to claim 1, wherein the container (20) is provided with a fourth coupling means (27) configured to mechanically engage with the foil holder (22).

7. The assembly according to claim 1, wherein the fourth coupling means (27) of the container (20) is provided with fixation openings (27a) for the foil holder (22) and the foil holder (22) is provided with fixation hooks (27b) configured to mechanically engage with the fixation openings of the fourth coupling means (27).

8. The assembly according to claim 1, wherein the container (20) and the adapter (30) are provided with two first openings (21a,b) and two second openings (31a,b), wherein one pair of first and second openings are provided for aseptic removal of a liquid from the container and the other pair of first and second openings are provided for aseptic flow of medium into the container.

9. The assembly according to claim 1, wherein the first and second foils (28, 38) are provided as double layers in form of loops, wherein one end of the first foil (28) is attached to the container (20) and the other end to the foil holder (22), and wherein one end of the second foil (38) is attached to the handle (33) and the other end is attached to the adapter (30).

10. The assembly according to claim 1, wherein the first coupling means (23) and second coupling means (32) are provided as complementary guiding slots or complementary tongue and groove.

11. The assembly according to claim 1, wherein the third coupling means (34) is provided as guiding slot complementary to the shape of the handle (33).

12. The assembly according to claim 1, wherein the handle (33) is provided with a snap-on connector (35) capable of mechanically interlocking with protrusion (39) provided at adapter (30) when inserting handle (33) into adapter (30).

13. The assembly according to claim 1, wherein the adapter (30) is provided with a snap-on connector (39) capable of mechanically interlocking with cavity (26) provided at container (20) when inserting the container (20) into adapter (30).

14. The assembly according to claim 1, wherein the container (20) is provided with an internal tube (41) extending from one opening (21a,b) at least to 25% of the internal height of the container (20).
